(19) United States
(12) Patent Application Publication
(10) Pub. No.: US 2024/0121847 A1
(43) Pub. Date: Apr. 11, 2024

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Lin LIANG, Beijing (CN); Gang WANG, Beijing (CN)

(73) Assignee: NEC CORPORATION, Tokyo (JP)

(21) Appl. No.: 18/276,935

(22) PCT Filed: Mar. 31, 2021
(86) PCT No.: PCT/CN2021/084694

§ 371 Date: Aug. 11, 2023

(51) Int. Cl. H04W 76/19

(52) U.S. Cl. CPC H04W 76/19

(57) ABSTRACT

Embodiments of the present disclosure relate to methods, devices and computer readable media for communication. A terminal device transmits uplink data in an inactive state to a network device, and if a resume of a connection with the network device is to be performed at a cell where the transmission has been performed, the terminal device performs the resume of the connection by at least one of the following: maintaining, in a PDCP re-establishment, a state variable of PDCP entities of UM DRBs or SRBs; or at least one of initiating a PDCP recovery for at least DRBs supporting a transmission in the inactive state or discarding PDCP SDUs and PDCP PDUs for SRBs supporting a transmission in the inactive state. In this way, security during a SDT procedure can be enhanced.

### TECHNICAL FIELD

Embodiments of the present disclosure generally relate to the field of telecommunication, and in particular, to methods, devices and computer storage media of communication during data transmission in an inactive state of a terminal device.

### BACKGROUND

Typically, a terminal device in an inactive state may still have small and infrequent data traffic to be transmitted. Until the third generation partnership project (3GPP) Release 16, the inactive state cannot support data transmission, and the terminal device has to resume connection (i.e., enter a connected state) for any downlink and uplink data. This will result in unnecessary power consumption and signaling overhead.

In this event, 3GPP Release 17 has approved small data transmission (SDT) in the inactive state. Thereby, the signaling overhead can be reduced. However, up to now, SDT-related techniques are still incomplete and to be further developed.

### SUMMARY

In general, embodiments of the present disclosure provide methods, devices and computer storage media for communication.

In a first aspect, there is provided a method of communication. The method comprises: transmitting, at a terminal device, uplink data in an inactive state to a network device; and in accordance with a determination that a resume of a connection with the network device is to be performed at a cell where the transmission has been performed, performing the resume of the connection by at least one of the following: maintaining, in a packet data convergence protocol (PDCP) re-establishment, a state variable of PDCP entities of unacknowledged mode (UM) data radio bearers (DRBs) or signaling radio bearers (SRBs); or at least one of initiating a PDCP recovery for at least DRBs supporting a transmission in the inactive state or discarding PDCP service data units (SDUs) and PDCP protocol data units (PDUs) for SRBs supporting a transmission in the inactive state.

In a second aspect, there is provided a method of communication. The method comprises: transmitting, at a terminal device, uplink data in an inactive state to a network device; and in accordance with a determination that a resume of a connection with the network device is requested to be performed at a cell where the transmission has been performed, entering an idle state.

In a third aspect, there is provided a method of communication. The method comprises: transmitting, at a terminal device, uplink data in an inactive state to a network device, wherein no message for rejecting the transmission is received from the network device during the transmission of the uplink data in the inactive state.

In a fourth aspect, there is provided a method of communication. The method comprises: transmitting, at a terminal device, uplink data in an inactive state to a network device; receiving, from the network device, a message for resuming a connection with the network device, the message indicating that a PDCP re-establishment is performed for radio bearers not supporting a transmission in the inactive state; and performing the resume by at least one of the following: performing the PDCP re-establishment for the radio bearers, or resuming the radio bearers not supporting a transmission in the inactive state.

In a fifth aspect, there is provided a method of communication. The method comprises: transmitting, at a terminal device, uplink data in an inactive state to a network device; receiving downlink data from the network device; and in accordance with a determination that a checking of integrity protection of the downlink data fails, entering an idle state.

In a sixth aspect, there is provided a method of communication. The method comprises: receiving, at a network device, uplink data transmitted from a terminal device in an inactive state, wherein no message for rejecting the transmission is transmitted from the network device to the terminal device after the receipt of the uplink data.

In a seventh aspect, there is provided a method of communication. The method comprises: receiving, at a network device, uplink data transmitted from a terminal device in an inactive state; and transmitting, to the terminal device, a message for resuming a connection between the terminal device and the network device for the uplink data, the message indicating that a PDCP re-establishment is performed for radio bearers not supporting a transmission in the inactive state.

In an eighth aspect, there is provided a terminal device. The terminal device comprises a processor and a memory coupled to the processor. The memory stores instructions that when executed by the processor, cause the terminal device to perform the method according to the first, second, third, fourth or fifth aspect of the present disclosure.

In a ninth aspect, there is provided a network device. The network device comprises a processor and a memory coupled to the processor. The memory stores instructions that when executed by the processor, cause the network device to perform the method according to the sixth or seventh aspect of the present disclosure.

In a tenth aspect, there is provided a computer readable medium having instructions stored thereon. The instructions, when executed on at least one processor, cause the at least one processor to perform the method according to the first, second, third, fourth or fifth aspect of the present disclosure.

In an eleventh aspect, there is provided a computer readable medium having instructions stored thereon. The instructions, when executed on at least one processor, cause the at least one processor to perform the method according to the sixth or seventh aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram of a user plane (UP) protocol stack in which some embodiments of the present disclosure can be implemented;

FIG. 1C illustrates a schematic diagram of a control plane (CP) protocol stack in which some embodiments of the present disclosure can be implemented;

FIG. 2A illustrates a schematic diagram illustrating a SDT procedure in which some embodiments of the present disclosure can be implemented;

FIG. 2B illustrates a schematic diagram illustrating a SDT procedure comprising initial transmission and subsequent transmission in which some embodiments of the present disclosure can be implemented;

FIG. 3 illustrates a schematic diagram illustrating a process for communication during a SDT procedure according to embodiments of the present disclosure;

FIG. 4 illustrates a schematic diagram illustrating another process for communication during a SDT procedure according to embodiments of the present disclosure;

FIG. 5 illustrates a schematic diagram illustrating another process for communication during a SDT procedure according to embodiments of the present disclosure;

FIG. 6 illustrates a schematic diagram illustrating another process for communication during a SDT procedure according to embodiments of the present disclosure;

FIG. 7 illustrates an example method of communication implemented at a terminal device in accordance with some embodiments of the present disclosure;

FIG. 8 illustrates another example method of communication implemented at a terminal device in accordance with some embodiments of the present disclosure;

FIG. 9 illustrates another example method of communication implemented at a terminal device in accordance with some embodiments of the present disclosure;

FIG. 10 illustrates another example method of communication implemented at a terminal device in accordance with some embodiments of the present disclosure;

FIG. 11 illustrates another example method of communication implemented at a terminal device in accordance with some embodiments of the present disclosure;

FIG. 12 illustrates an example method of communication implemented at a network device in accordance with some embodiments of the present disclosure;

FIG. 13 illustrates another example method of communication implemented at a network device in accordance with some embodiments of the present disclosure; and

FIG. 14 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment. ‘The term’ another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

Currently, there are various applications that involve exchange of small and infrequency data. For example, in some applications of mobile devices, SDT may involve traffic from Instant Messaging (IM) services, heart-beat or keep-alive traffic, for example, from IM or email clients and other services, push notifications in various applications, traffic from wearables (including, for example, periodic positioning information), and/or the like. In some applications of non-mobile devices, SDT may involve sensor data (e.g., temperature, pressure readings transmitted periodically or in an event-triggered manner in an IoT network), metering and alerting information sent from smart meters, and/or the like.

In some scenarios, during a SDT procedure where a terminal device transmits uplink data in an inactive state, the terminal device may trigger another RRC resume procedure for legacy data transmission or SDT due to receipt of a RRCReject message or a RRCResume message or any other factors. In this case, if the RRC resume procedure is triggered in the same cell as that for the current SDT, there will be security issues.

In some other scenarios, during a subsequent transmission in a SDT procedure, there may be no DL RRC message sent from a network device before the end of the SDT procedure, and thus a terminal device cannot verify the network device by checking integrity protection of the DL RRC message. In the case that the network device is a malicious party, the terminal device may continuously receive useless DL data. In this case, there will also be security issues.

For the above or other potential scenarios, embodiments of the present disclosure provide solutions of communication for handling the security issues during the SDT procedure. Principles and implementations of the present disclosure will be described in detail below with reference to the figures.

### Example of Communication Environment

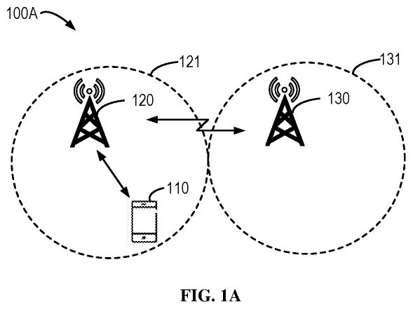

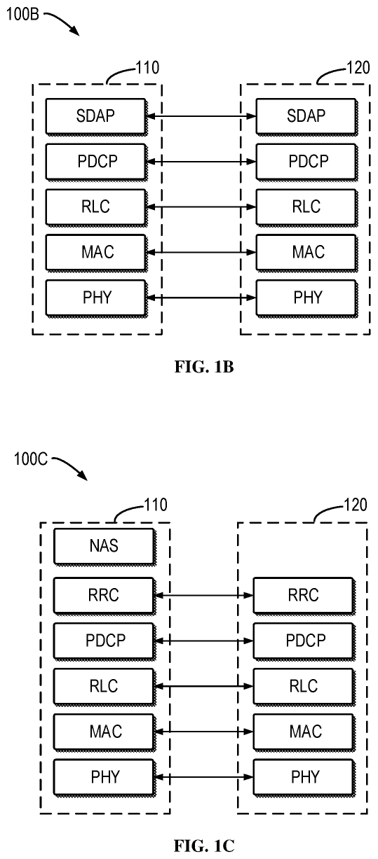

FIG. 1A illustrates a schematic diagram of an example communication network 100 in which some embodiments of the present disclosure can be implemented. As shown in FIG. 1A, the communication network 100 may include a terminal device 110 and a plurality of network devices 120 and 130. The network devices 120 and 130 provide respective cells 121 and 131 to serve a terminal device. In the example of FIG. 1A, the terminal device 130 is located within the cell 121 of the network device 120, and the terminal device 130 may communicate with the network device 120. The cell 121 may be referred to as a serving cell of the terminal device 130.

It is to be understood that the number of devices in FIG. 1A is given for the purpose of illustration without suggesting any limitations to the present disclosure. The communication network 100 may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 via a channel such as a wireless communication channel. The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Communication in a direction from the terminal device 110 towards the network device 120 or 130 is referred to as UL communication, while communication in a reverse direction from the network device 120 or 130 towards the terminal device 110 is referred to as DL communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100 can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and L3 layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. In the context of the present disclosure, a DRB may be configured as supporting a transmission in an inactive state (i.e., supporting SDT). Of course, a DRB may also be configured as not supporting a transmission in an inactive state. A SRB may be configured as supporting a transmission in an inactive state. Of course, a SRB may also be configured as not supporting a transmission in an inactive state.

Three types of SRBs are defined in a RRC layer, i.e., SRB0, SRB1 and SRB2. SRB0 uses a CCCH for RRC connection establishment or re-establishment. SRB1 uses a DCCH and is established when RRC connection is established. SRB2 uses a DCCH and is established during RRC reconfiguration and after initial security activation.

In addition, a protocol data unit (PDU) session may be established at the NAS layer of the terminal device 110 to transmit data to CN or receive data from CN. A PDU session may correspond to a SDAP entity, and may comprise a plurality of quality of service (QoS) flows. In the context of the present disclosure, a QoS flow may be configured as supporting a transmission in an inactive state. Of course, a QoS flow may also be configured as not supporting a transmission in an inactive state.

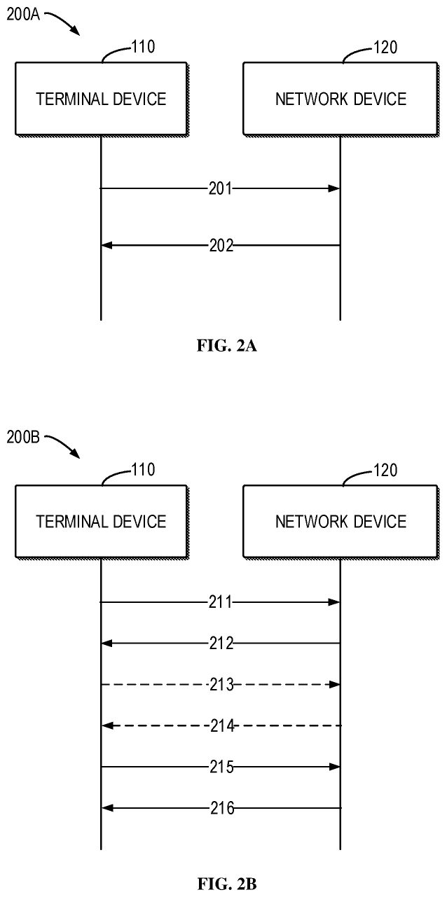

In the context of the present disclosure, the terminal device 110 may communicate with the network device 120 in an inactive state. In some scenarios, when the terminal device 110 has small and infrequency data traffic from radio bearer supporting a transmission in inactive state to be transmitted, the terminal device 110 may initiate a SDT procedure. Whether one radio bearer supporting a transmission in inactive state is configured by the network device 120 or other network device. FIG. 2A illustrates a schematic diagram illustrating a SDT procedure 200A for one-shot in which some embodiments of the present disclosure can be implemented. As shown in FIG. 2A, the terminal device 110 in an inactive state may transmit 201, to the network device 120, a RRC resume request with UL data associated with the data traffic. For example, the terminal device 110 may transmit the RRC resume request with UL data in Msg A of a 2-step RACH procedure or in Msg3 of a 4-step RACH procedure. Of course, the terminal device 110 may also transmit the RRC resume request with UL data in a configured grant (CG) resource. The RRC resume request may comprise a resume cause. Upon receipt of the RRC resume request and the UL data, the network device 120 may transmit 202 a RRC release message with DL data corresponding to the UL data to the terminal device 110. For example, the network device 120 may transmit the RRC release message with the DL data in Msg B of a 2-step RACH procedure or in Msg4 of a 4-step RACH procedure. Or the network device 120 may transmit the RRC release message with DL data as response of the transmission at the CG resource. So far, the SDT procedure 200A ends.

FIG. 2B illustrates a schematic diagram illustrating a SDT procedure 200B comprising initial transmission and subsequent transmission in which some embodiments of the present disclosure can be implemented. As shown in FIG. 2B, the terminal device 110 in an inactive state may transmit 211, to the network device 120, a RRC resume request with UL data and a BSR. For example, the terminal device 110 may transmit the RRC resume request with the UL data and the BSR in Msg A of a 2-step RACH procedure or in Msg3 of a 4-step RACH procedure. Of course, the terminal device 110 may also transmit the RRC resume request with UL data in a configured grant (CG) resource. The RRC resume request may comprise a resume cause. Upon receipt of the RRC resume request with the UL data and the BSR, the network device 120 may transmit 212 an indication of subsequent transmission to the terminal device 110. For example, the network device 120 may transmit an explicit RRC message indicating the subsequent transmission. As another example, the network device 120 may transmit an UL grant for further transmission so as to implicitly indicating the subsequent transmission. In some embodiments, the network device 120 may transmit DL data with the indication to the terminal device 110. So far, the initial transmission is done.

Based on the indication, the terminal device 110 may transmit 213 further UL data and BSR to the network device 120, for example, based on a dynamic grant or configured grant. Then the network device 120 may transmit 214 an UL grant for dynamic grant to the terminal device 110. In some embodiments, the network device 120 may transmit DL data with the UL grant to the terminal device 110. Based on the UL grant from the network device 120, the terminal device 110 may transmit 215 remaining UL data to the network device 120. Accordingly, the network device 120 may transmit 216 RRC release message to the terminal device 110. So far, subsequent transmission is done. That is, the SDT procedure 200B ends. It is to be understood that the SDT procedure 200B may comprise more or less steps in the subsequent transmission.

### Example Implementation of Security Upon Initiation of Another RRC Resume Procedure During SDT

As mentioned above, in some scenarios, during a SDT procedure where a terminal device transmits uplink data in an inactive state, the terminal device may trigger another RRC resume procedure for legacy data transmission or SDT. For example, in some scenarios, the terminal device may receive a RRCReject message for the SDT procedure. In some scenarios, there may be further uplink data arriving from at least one radio bearer not supporting a transmission in an inactive state. In some scenarios, the terminal device may detect that a reference signal receive power (RSRP) threshold is not fulfilled during the SDT procedure. In some scenarios, the terminal device may perform a cell reselection from a source cell to a target cell, or in some cases, the terminal device may move back to the source cell. In these scenarios, the terminal device may trigger another RRC resume procedure for legacy data transmission or SDT.

However, if the RRC resume procedure is triggered in the same cell using the same UE context or security key as that for the previous SDT procedure, there will be security issues as it is possible that different PDCP SDUs are ciphered using the same security key and same COUNT value.

The state variable TX_NEXT indicates the COUNT value of the next PDCP SDU to be transmitted. In some embodiments, an initial value of the state variable is 0, except for SRBs configured with state variables continuation.

During a PDCP suspend procedure, the TX_NEXT is set to the initial value, which is currently performed upon the terminal device going to INACTIVE state.

During the RRC resume procedure, a PDCP re-establishment is performed where a state variable TX_NEXT for unacknowledged mode (UM) DRBs and SRBs is set to an initial value.

In this case, if the RRC resume procedure is triggered in the same cell as that for the previous SDT procedure using the current UE context, the packets to be transmitted during or after the RRC resume procedure by SDT or legacy data transmission will be ciphered using the same security key and COUNT value as that for the previous transmitted packets. However, the packets to be transmitted during or after the RRC resume procedure may be different from the previous transmitted packets in the previous SDT procedure. Thus, this will results in different packets being ciphered using the same security key and COUNT value, which is not allowed from safety point of view.

In view of this, embodiments of the present application provide solutions for handling the security issues in order to not resetting the state variable TX_NEXT and avoid the different packets being ciphered using the same security key and COUNT value. This will be described below in connection with Embodiments 1 to 4.

### Embodiment 1

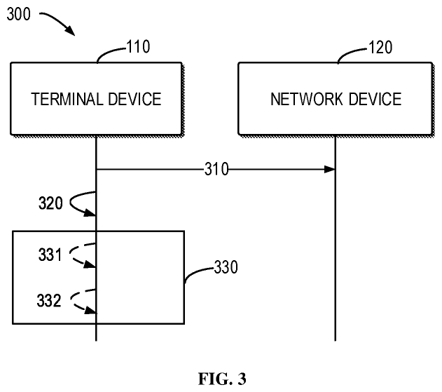

In some scenarios, a SDT procedure may be interrupted, and then the terminal device may trigger another RRC resume procedure at the same cell in which the SDT procedure has been performed. This embodiment is directed to provide a solution for enhancing a security in these scenarios, which will be detailed below with reference to FIG. 3.

FIG. 3 illustrates a schematic diagram illustrating a process 300 for communication during a SDT procedure according to embodiments of the present disclosure. For the purpose of discussion, the process 300 will be described with reference to FIG. 1. The process 300 may involve the terminal device 110 and the network device 120 as illustrated in FIG. 1.

As shown in FIG. 3, the terminal device 110 transmits 310 uplink data in an inactive state to the network device 120. In other words, the terminal device 110 performs a SDT procedure. In some embodiments, the terminal device 110 may abort the SDT procedure.

For example, in some embodiments, the terminal device 110 may abort the SDT procedure in response to receiving a message (e.g., RRCReject message) for rejecting the transmission. In some examples, the terminal device 110 may abort the SDT procedure in response to further uplink data arriving from at least one radio bearer not supporting a transmission in the inactive state (i.e., not supporting SDT). In some examples, the terminal device 110 may abort the SDT procedure in response to the NAS layer or AS layer requesting transition to RRC Connected state. In some embodiments, the terminal device 110 may abort the SDT procedure in response to receive signal power (for example, RSRP) of a serving cell of the terminal device 110 being lower than a threshold power. In some embodiments, the terminal device 110 may abort the SDT procedure in response to a cell reselection being performed from a first cell to a second cell. These merely are examples, any other suitable conditions may also be feasible for aborting the SDT procedure.

In some embodiments, the terminal device 110 may abort the SDT procedure by at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state (i.e., all radio bearers or only radio bearers supporting SDT); suspending SRB1 and at least radio bearers supporting a transmission in the inactive state (i.e., all radio bearers or only radio bearers supporting SDT). It is to be noted that more or less actions may also be comprised in aborting the SDT procedure.

If a resume of a connection with the network device 120 is initiated, the terminal device 110 determines 320 whether the resume of the connection is to be performed at a cell where the SDT procedure has been performed. In some embodiments, the terminal device 110 may also determine whether the same UE context or the same security key is to be used as that for the SDT procedure. If the resume of the connection is to be performed at the cell, the terminal device 110 performs 330 the resume of the connection as described in Option 1 or 2 or both. In some embodiments, if the resume of the connection is to be performed at the cell and the same UE context or the same security key is to be used, the terminal device 110 may perform the resume of the connection as described in Option 1 or 2 or both.

### Option 1

In some embodiments, the terminal device 110 may maintain 331 a state variable (i.e., TX_NEXT) of PDCP entities of unacknowledged mode (UM) DRBs or SRBs in the PDCP re-establishment for the resume of the connection. That is, the TX_NEXT of PDCP entities of the UM DRBs or SRBs is not set to the initial value in the RRC resume procedure. In this way, the first packet to be transmitted upon the RRC resume procedure can be ciphered with a different COUNT value from that for the previous transmitted packet in the SDT procedure.

For example, the terminal device 110 may abort or terminate the SDT procedure by at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state (i.e., all radio bearers or only radio bearers supporting SDT); or suspending SRB1 and at least radio bearers supporting a transmission in the inactive state (i.e., all radio bearers or only radio bearers supporting SDT).

Upon initiating RRC connection resume for SDT or legacy data transmission, if this is the cell where RRCReject is received during the previous SDT procedure (or at the cell where the terminal device 110 has performed the previous SDT procedure using the current UE context or same security keys), the terminal device 110 may perform the following behavior in the RRC resume procedure. For example, in case of legacy data transmission, the network device 120 may configure the terminal device 110 to perform PDCP re-establishment for DRB and SRB2 in RRCResume message. In case of SDT, the RRC layer of the terminal device 110 may initiate PDCP re-establishment for the DRB or SRBs supporting a transmission in an inactive state. When the RRC layer indicates PDCP entities of the radio bearer configured with SDT to perform re-establishment, the RRC layer shall also indicate to PDCP that TX_NEXT not initialized during the re-establishment for UM DRBs and SRBs.

If the resume of the connection is to be performed at a further cell different from the cell where the SDT procedure has been performed, the terminal device 110 may perform the PDCP re-establishment without indicating that TX_NEXT is not initialized for the UM DRBs and SRBs. In some embodiments, the terminal device 110 may also perform PDCP suspend for DRBs before a PDCP re-establishment.

For example, the related content of the modified 3GPP specification would be as below:
When upper layers request a PDCP entity re-establishment, the transmitting PDCP entity shall:
   for UM DRBs and AM DRBs, reset the ROHC protocol for uplink and start with an IR state in U-mode (as defined in RFC 3095 [8] and RFC 4815 [9]) if drb-ContinueROHC is not configured in TS 38.331 [3];
   for UM DRBs and AM DRBs, reset the EHC protocol for uplink if drb-ContinueEHC-UL is not configured in TS 38.331 [3];
   If the upper layers didn't indicate to maintain TX_NEXT value, for UM DRBs and SRBs, set TX_NEXT to the initial value;
for SRBs, discard all stored PDCP SDUs and PDCP PDUs.

### Option 2

In some embodiments, the terminal device 110 may perform 332 the resume of the connection by at least one of the following: initiating a PDCP recovery for at least DRBs supporting a transmission in the inactive state (i.e., all DRBs or only DRBs supporting SDT), or discarding (also referred to as SDU discard herein) PDCP SDUs and PDCP PDUs for SRBs supporting a transmission in the inactive state, or both. In this way, the state variable TX_NEXT is also not reset during the resume of the connection and thus the security issue is avoided.

For example, the terminal device 110 may abort or terminate the SDT procedure by at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state (i.e., all radio bearers or only radio bearers supporting SDT); suspending SRB1 and at least radio bearers supporting a transmission in the inactive state (i.e., all radio bearers or only radio bearers supporting SDT).

When the NAS layer or AS layer requests the terminal device 110 to resume RRC connection for SDT or legacy data transmission, if this is the cell where RRCReject is received during the SDT procedure, or at the cell where the terminal device 110 has performed the SDT procedure using the current UE context, the terminal device 110 may perform the following behavior in the RRC resume procedure. For example, in case of legacy data transmission, the network device 120 may configure the terminal device 110 to perform PDCP recovery for DRBs and SDU discard for SRBs in RRC resume message.

In case of SDT, the RRC layer of the terminal device 110 may initiate PDCP recovery for the DRBs configured with SDT and SDU discard for SRBs configured with SDT. If the resume of the connection is to be performed at a further cell different from the cell where the SDT procedure has been performed, the terminal device 110 may perform the PDCP re-establishment without indicating that TX_NEXT is not initialized. In some embodiments, the terminal device 110 may perform PDCP suspend for at least the DRBs supporting a transmission in an inactive state (i.e., all DRBs or only DRBs supporting SDT) before a PDCP re-establishment.

### Embodiment 2

This embodiment is directed to provide a solution for enhancing a security upon receipt of a message (e.g., RRCReject message) for rejecting a SDT procedure during the SDT procedure. In the solution, the network device 120 is not allowed to send a message for rejecting a SDT procedure to the terminal device 110 during the SDT procedure.

In this way, the terminal device 100 will not receive the RRCReject message and thus will not trigger the RRC resume procedure. As a result, the security issue caused by the RRC resume procedure can be avoided.

### Embodiment 3

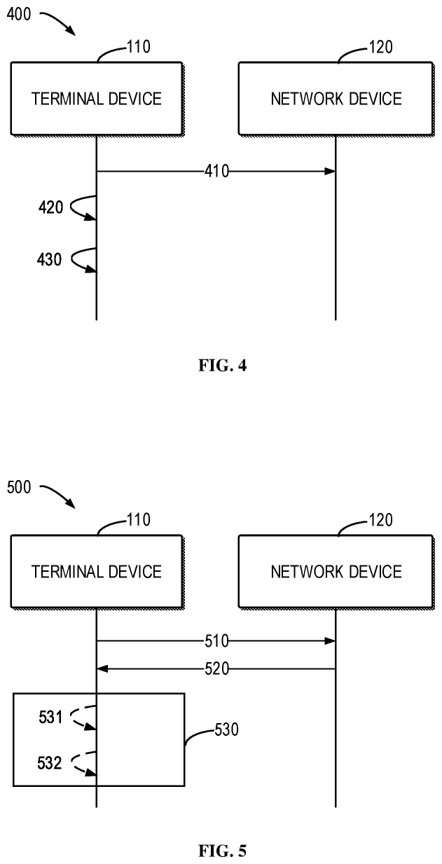

In this embodiment, the terminal device 110 is not allowed to initiate another RRC resume procedure at the same cell in which the SDT procedure has been performed. This will be detailed below with reference to FIG. 4.

FIG. 4 illustrates a schematic diagram illustrating a process 400 for communication during a SDT procedure according to embodiments of the present disclosure. For the purpose of discussion, the process 400 will be described with reference to FIG. 1. The process 400 may involve the terminal device 110 and the network device 120 as illustrated in FIG. 1.

As shown in FIG. 4, the terminal device 110 transmits 410 uplink data in an inactive state to the network device 120. In other words, the terminal device 110 performs a SDT procedure.

In some embodiments, the terminal device 110 may abort the SDT procedure. For example, in some embodiments, the terminal device 110 may abort the SDT procedure in response to receiving a message (e.g., RRCReject message) for rejecting the transmission. In some examples, the terminal device 110 may abort the SDT procedure in response to further uplink data arriving from at least one radio bearer not supporting a transmission in the inactive state. In some examples, the terminal device 110 may abort the SDT procedure in response to the NAS layer or AS layer requesting transition to RRC Connected state. In some embodiments, the terminal device 110 may abort the SDT procedure in response to receive signal power (for example, RSRP) of a serving cell of the terminal device 110 being lower than a threshold power. In some embodiments, the terminal device 110 may abort the SDT procedure in response to a cell reselection being performed from a first cell to a second cell. These merely are examples, any other suitable conditions may also be feasible for aborting the SDT procedure.

In some embodiments, the terminal device 110 may abort the SDT procedure by at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state (i.e., all radio bearers or only radio bearers supporting SDT); suspending SRB1 and at least radio bearers supporting a transmission in the inactive state (i.e., all radio bearers or only radio bearers supporting SDT); or performing PDCP suspend for at least DRBs supporting a transmission in an inactive state (i.e., all DRBs or only DRBs supporting SDT). It is to be noted that more or less actions may also be comprised in aborting the SDT procedure.

During the SDT procedure, the terminal device 110 determines 420 whether a resume of a connection with the network device 120 is requested to be performed at a cell where the SDT procedure has been performed. If the resume of the connection is to be performed at the cell, the terminal device 110 enters 430 an idle state.

For example, if the NAS layer or AS layer of the terminal device 110 requests the RRC layer of the terminal device 110 to resume RRC connection for SDT or legacy data transmission, if this is the cell where RRCReject is received during the SDT procedure (or at the cell where the terminal device 110 has performed the SDT procedure using the current UE context), the terminal device 110 may perform the behavior upon going to an RRC IDLE state, with a release cause “RRC Resume failure”.

In this way, the terminal device 100 will not trigger the RRC resume procedure during the SDT procedure and thus the security issue can also be avoided.

### Embodiment 4

Embodiments 1 to 3 describe solutions from a point of view of a terminal device. In this embodiment, a solution is proposed from a point of view of a network device. In this solution, the network device only indicates re-establishPDCP to radio bearers not supporting SDT in RRCResume message during SDT. This will be detailed below with reference to FIG. 5.

FIG. 5 illustrates a schematic diagram illustrating a process 500 for communication during a SDT procedure according to embodiments of the present disclosure. For the purpose of discussion, the process 500 will be described with reference to FIG. 1. The process 500 may involve the terminal device 110 and the network device 120 as illustrated in FIG. 1.

As shown in FIG. 5, the terminal device 110 transmits 510 uplink data in an inactive state to the network device 120. In other words, the terminal device 110 performs a SDT procedure.

Upon receipt of the uplink data, the network device 120 may indicate the terminal device 110 to transfer to non-SDT mode. In this case, during the SDT procedure (in an initial transmission phase or in a subsequent transmission phase), the network device 120 transmits 520 a message (e.g., RRCResume message) for resuming a connection with the network device 120. In some embodiments, the message indicates that a PDCP re-establishment is performed for radio bearers not supporting a transmission in the inactive state (i.e., not supporting SDT).

For example, the related content of the modified 3GPP specification would be as below:

reestablishPDCP
indicates that PDCP should be re-established. Network sets this to true whenever the security key used for this radio bearer changes. Key change could for example be due to termination point change for the bearer, reconfiguration with sync, resuming an RRC connection, or the first reconfiguration after reestablishment. It is also applicable for LTE procedures when NR PDCP is configured. Network doesn't include this field for DRB if the bearer is configured as DAPS bearer. It is only indicated to the radio bearers not supporting SDT when resuming an RRC connection during SDT

Upon receipt of the message, the terminal device 110 performs 530 the resume of the connection based on the message. In some embodiments, the terminal device 110 may perform 531 the PDCP re-establishment only for the radio bearers not supporting SDT. In some embodiments, the terminal device 110 may resume 531 the radio bearers not supporting SDT.

In this way, the state variable TX_NEXT of the SDT DRBs is also not reset during the resume of the connection and thus the security issue can be avoided.

### Example Implementation of Security During Subsequent Transmission

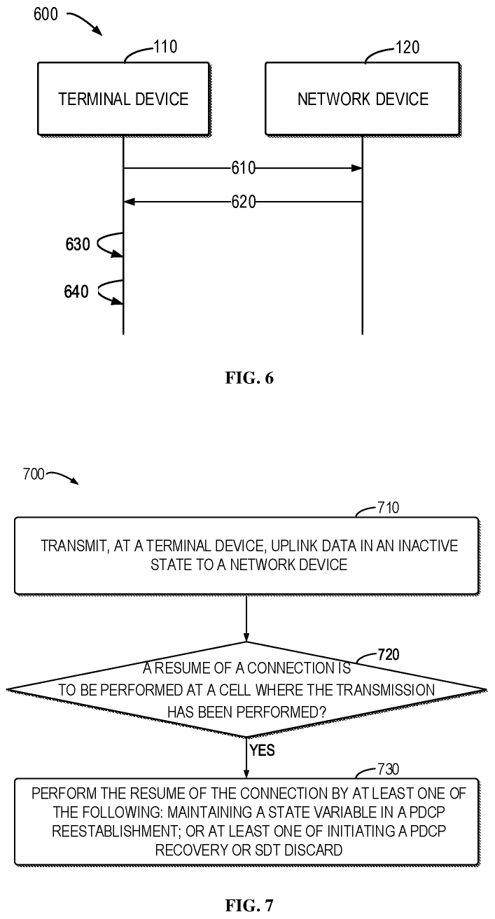

As mentioned above, during a subsequent transmission in a SDT procedure, there may be no DL RRC message sent from a network device before the end of the SDT procedure, and thus a terminal device cannot verify the network device by checking integrity protection of the DL RRC message. In this case, there will also be security issues. In view of this, embodiments of the present disclosure propose a solution of verifying the network device by checking integrity protection of DL DRB data. This will be detailed below with reference to FIG. 6.

FIG. 6 illustrates a schematic diagram illustrating a process 600 for communication during a SDT procedure according to embodiments of the present disclosure. For the purpose of discussion, the process 600 will be described with reference to FIG. 1. The process 600 may involve the terminal device 110 and the network device 120 as illustrated in FIG. 1.

As shown in FIG. 6, the terminal device 110 transmits 610 uplink data in an inactive state to the network device 120. In other words, the terminal device 110 performs a SDT procedure.

During the SDT procedure, the terminal device 110 may receive 620 DL data from the network device 120. Accordingly, the terminal device 110 may check 630 integrity protection of the DL data.

If the integrity protection of the downlink data fails, the terminal device 110 enters 640 an idle state. In some embodiments, the terminal device 110 may store information of the failure. For example, during the SDT procedure, upon an indication of integrity protection check failure from lower layers (e.g., PDCP) concerning DRBs, the RRC layer of the terminal device 110 may store the connection resume failure information. Optionally, the RRC layer may indicate the cause of the failure as integrity check failure. For example, the terminal device 110 may perform the behavior upon going to an RRC IDLE state with a release cause “RRC Resume failure”.

In this way, the terminal device 110 can terminate unsafe SDT procedure once it detects integrity failure concerning the DRBs, and thus the security can be enhanced.

### Example Implementation of Methods

Accordingly, embodiments of the present disclosure provide methods of communication implemented at a terminal device and a network device. These methods will be described below with reference to FIGS. 7 to 13.

FIG. 7 illustrates an example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 transmits uplink data in an inactive state to the network device 120.

At block 720, the terminal device 110 determines whether a resume of a connection with the network device is to be performed at a cell where the transmission has been performed. If the resume of the connection is to be performed at the cell, the process proceeds to block 730. In some embodiments, the terminal device 110 may also determine whether the same UE context or the same security key is to be used, and if the same UE context or the same security key is to be used, the terminal device 110 may perform the resume of the connection.

At block 730, the terminal device 110 performs the resume of the connection by at least one of the following: maintaining, in a PDCP re-establishment, a state variable of PDCP entities of UM DRBs or SRBs; or at least one of initiating a PDCP recovery for at least DRBs supporting a transmission in the inactive state or discarding PDCP SDUs and PDCP PDUs for SRBs supporting a transmission in the inactive state.

In some embodiments, during the transmission, the terminal device 110 may abort the transmission in response to at least one of the following: receiving, from the network device, a message for rejecting the transmission; further uplink data arriving from at least one radio bearer not supporting a transmission in the inactive state; a NAS layer or an AS layer of the terminal device requesting a transition to a connected state; receive signal power of a serving cell of the terminal device 110 being lower than a threshold power; or a cell reselection being performed from a first cell to a second cell.

In some embodiments, aborting the transmission may comprise at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state; suspending SRB1 and at least the radio bearers supporting a transmission in the inactive state; or performing PDCP suspend at least for DRBs supporting a transmission in an inactive state (i.e., all DRBs or only DRBs supporting SDT).

In some embodiments, if the resume of the connection is to be performed at a further cell different from the cell where the transmission has been performed, the terminal device 110 may perform the resume of the connection by initiating the state variable in the PDCP re-establishment. In some embodiments, the terminal device 110 may perform PDCP suspend for at least DRBs supporting a transmission in an inactive state before the PDCP re-establishment.

In this way, the security issue caused by RRC resume after SDT abortion can be avoided. The implementations of the method described in FIG. 7 substantially correspond to that described in Option 1 and Option 2 of Embodiment 1, and thus other details are not repeated here.

FIG. 8 illustrates another example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

As shown in FIG. 8, at block 810, the terminal device 110 transmits uplink data in an inactive state to the network device 120.

At block 820, the terminal device 110 determines whether a resume of a connection with the network device is requested to be performed at a cell where the transmission has been performed. If the resume of the connection is requested to be performed at the cell, the process proceeds to block 830. In some embodiments, the terminal device 110 may determine whether the same UE context or the same security key is to be used, and if the same UE context or the same security key is to be used, the terminal device 110 may enter the idle state.

At block 830, the terminal device 110 enters an idle state. In some embodiments, during the transmission, the terminal device 110 may abort the transmission in response to at least one of the following: receiving, from the network device, a message for rejecting the transmission; further uplink data arriving from at least one radio bearer not supporting a transmission in the inactive state; a NAS layer or an AS layer of the terminal device requesting a transition to a connected state; receive signal power of a serving cell of the terminal device 110 being lower than a threshold power; or a cell reselection being performed from a first cell to a second cell.

In some embodiments, aborting the transmission may comprise at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state; suspending SRB1 and at least radio bearers supporting a transmission in the inactive state; or performing PDCP suspend for DRBs.

In some embodiments, if the resume of the connection is to be performed at a further cell different from the cell where the transmission has been performed, the terminal device 110 may perform the resume of the connection by initiating the state variable in the PDCP re-establishment. In some embodiments, the terminal device 110 may perform PDCP suspend for at least DRBs supporting a transmission in an inactive state before the PDCP re-establishment.

In this way, the security issue caused by RRC resume after SDT abortion can also be avoided. The implementations of the method described in FIG. 8 substantially correspond to that described in Embodiment 3, and thus other details are not repeated here.

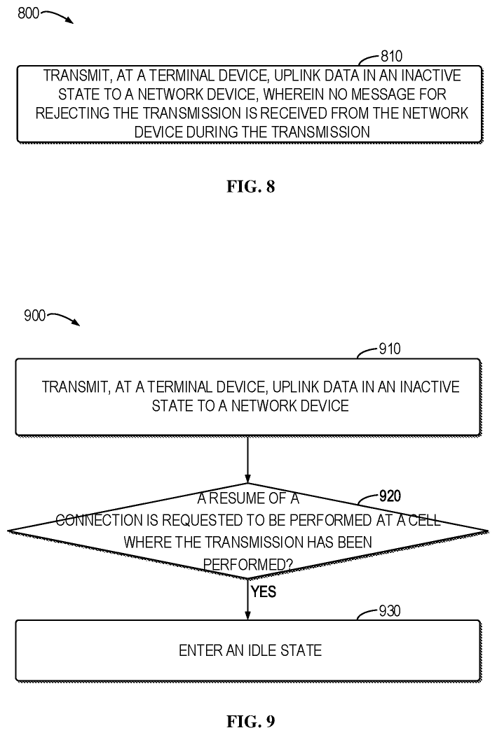

FIG. 9 illustrates another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

As shown in FIG. 9, at block 910, the terminal device 110 transmits uplink data in an inactive state to the network device 120, wherein no message for rejecting the transmission is received from the network device during the transmission of the uplink data in the inactive state.

In this way, the security issue caused by RRC resume upon receipt of RRC reject message can be avoided. The implementations of the method described in FIG. 9 substantially correspond to that described in Embodiment 2, and thus other details are not repeated here.

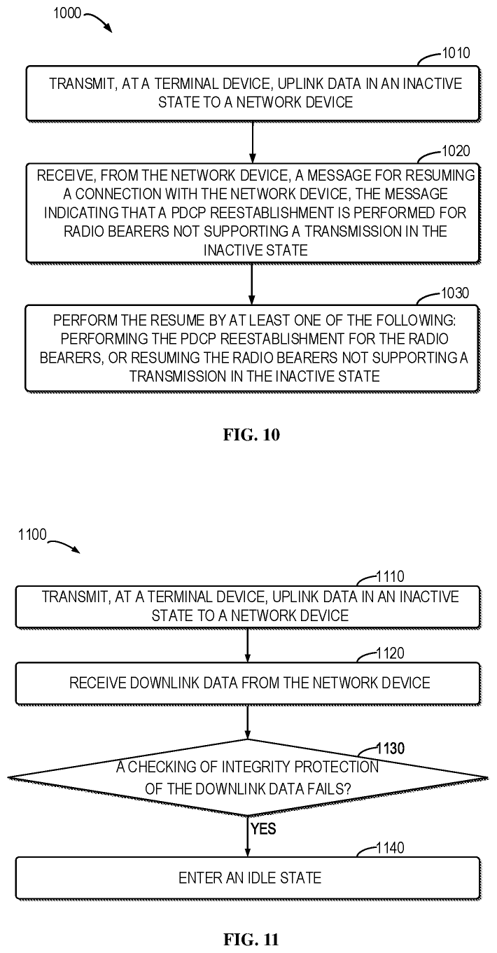

FIG. 10 illustrates another example method 1000 of communication implemented at a terminal device in accordance with some embodiments of the present disclosure. For example, the method 1000 may be performed at the terminal device 110 as shown in FIG. 1. For the purpose of discussion, in the following, the method 1000 will be described with reference to FIG. 1. It is to be understood that the method 1000 may include additional blocks not shown and/or may omit some blocks as shown, and the scope of the present disclosure is not limited in this regard.

As shown in FIG. 10, at block 1010, the terminal device 110 transmits uplink data in an inactive state to the network device 120.

At block 1020, the terminal device 110 receives, from the network device 120, a message for resuming a connection with the network device, the message indicating that a PDCP re-establishment is performed for radio bearers not supporting a transmission in the inactive state.

At block 1030, the terminal device 110 performs the resume by at least one of the following: performing the PDCP re-establishment for the radio bearers, or resuming the radio bearers not supporting a transmission in the inactive state.

In this way, the security issue caused by RRC resume can be avoided from the network side. The implementations of the method described in FIG. 10 substantially correspond to that described in Embodiment 4, and thus other details are not repeated here.

FIG. 11 illustrates another example method 1100 of communication implemented at a terminal device in accordance with some embodiments of the present disclosure. For example, the method 1100 may be performed at the terminal device 110 as shown in FIG. 1. For the purpose of discussion, in the following, the method 1100 will be described with reference to FIG. 1. It is to be understood that the method 1100 may include additional blocks not shown and/or may omit some blocks as shown, and the scope of the present disclosure is not limited in this regard.

As shown in FIG. 11, at block 1110, the terminal device 110 transmits uplink data in an inactive state to the network device 120. At block 1120, the terminal device 110 receives downlink data from the network device 120.

At block 1130, the terminal device 110 determines whether a checking of integrity protection of the downlink data fails. If the checking fails, the terminal device 110 enters an idle state. In some embodiments, the terminal device 110 may store information of the failure.

In this way, the security during subsequent transmission in a SDT procedure can be enhanced. The implementations of the method described in FIG. 11 substantially correspond to that described in connection with FIG. 6, and thus other details are not repeated here.

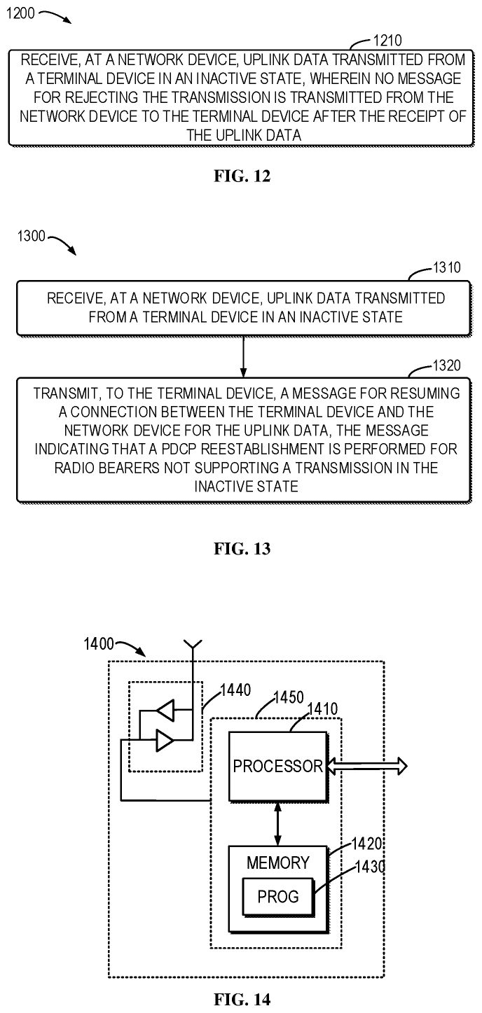

FIG. 12 illustrates an example method 1200 of communication implemented at a network device in accordance with some embodiments of the present disclosure. For example, the method 1200 may be performed at the network device 120 as shown in FIG. 1. For the purpose of discussion, in the following, the method 1200 will be described with reference to FIG. 1. It is to be understood that the method 1200 may include additional blocks not shown and/or may omit some blocks as shown, and the scope of the present disclosure is not limited in this regard.

As shown in FIG. 12, at block 1210, the network device 120 receives uplink data transmitted from the terminal device 110 in an inactive state, wherein no message for rejecting the transmission is transmitted from the network device 120 to the terminal device 110 after the receipt of the uplink data.

In this way, the security issue caused by RRC resume upon receipt of RRC reject message can be avoided. The implementations of the method described in FIG. 12 substantially correspond to that described in Embodiment 2, and thus other details are not repeated here.

FIG. 13 illustrates an example method 1300 of communication implemented at a network device in accordance with some embodiments of the present disclosure. For example, the method 1300 may be performed at the network device 120 as shown in FIG. 1. For the purpose of discussion, in the following, the method 1300 will be described with reference to FIG. 1. It is to be understood that the method 1300 may include additional blocks not shown and/or may omit some blocks as shown, and the scope of the present disclosure is not limited in this regard.

As shown in FIG. 13, at block 1310, the network device 120 receives uplink data transmitted from the terminal device 120 in an inactive state.

At block 1320, the network device 120 transmits, to the terminal device 110, a message for resuming a connection between the terminal device 110 and the network device 120 for the uplink data, the message indicating that a PDCP re-establishment is performed for radio bearers not supporting a transmission in the inactive state.

In this way, the security issue caused by RRC resume can be avoided at the network side. The implementations of the method described in FIG. 13 substantially correspond to that described in Embodiment 4, and thus other details are not repeated here.

### Example Implementation of Device

FIG. 14 is a simplified block diagram of a device 1400 that is suitable for implementing embodiments of the present disclosure. The device 1400 can be considered as a further example implementation of the terminal device 110 or the network device 120 or 130 as shown in FIG. 1. Accordingly, the device 1400 can be implemented at or as at least a part of the terminal device 110 or the network device 120 or 130.

As shown, the device 1400 includes a processor 1410, a memory 1420 coupled to the processor 1410, a suitable transmitter (TX) and receiver (RX) 1440 coupled to the processor 1410, and a communication interface coupled to the TX/RX 1440. The memory 1410 stores at least a part of a program 1430. The TX/RX 1440 is for bidirectional communications. The TX/RX 1440 has at least one antenna to facilitate communication, though in practice an Access Node mentioned in this application may have several ones.

The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1430 is assumed to include program instructions that, when executed by the associated processor 1410, enable the device 1400 to operate in accordance with the embodiments of the present disclosure, as discussed herein with reference to FIGS. 1 to 13. The embodiments herein may be implemented by computer software executable by the processor 1410 of the device 1400, or by hardware, or by a combination of software and hardware. The processor 1410 may be configured to implement various embodiments of the present disclosure. Furthermore, a combination of the processor 1410 and memory 1420 may form processing means 1450 adapted to implement various embodiments of the present disclosure.

The memory 1420 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1420 is shown in the device 1400, there may be several physically distinct memory modules in the device 1400. The processor 1410 may be of any type suitable to the local technical network, and may include one or more of general purpose computers, special purpose computers, microprocessors, digital signal processors (DSPs) and processors based on multicore processor architecture, as non-limiting examples. The device 1400 may have multiple processors, such as an application specific integrated circuit chip that is slaved in time to a clock which synchronizes the main processor.

In some embodiments, a terminal device comprises circuitry configured to: transmit, at a terminal device, uplink data in an inactive state to a network device; and in accordance with a determination that a resume of a connection with the network device is to be performed at a cell where the transmission has been performed, perform the resume of the connection by at least one of the following: maintaining, in a PDCP re-establishment, a state variable of PDCP entities of UM DRBs or SRBs; or at least one of initiating a PDCP recovery for at least DRBs supporting a transmission in the inactive state or discarding PDCP SDUs and PDCP PDUs for SRBs supporting a transmission in the inactive state.

In some embodiments, the circuitry may be further configured to: determine whether the same UE context or the same security key is to be used, and if the same UE context or the same security key is to be used, perform the resume of the connection.

In some embodiments, the circuitry may be configured to abort the transmission in response to at least one of the following during the transmission: receiving, from the network device, a message for rejecting the transmission; further uplink data arriving from at least one radio bearer not supporting a transmission in the inactive state; a NAS layer or an AS layer of the terminal device requesting a transition to a connected state; receive signal power of a serving cell of the terminal device being lower than a threshold power; or a cell reselection being performed from a first cell to a second cell.

In some embodiments, the circuitry may be configured to abort the transmission by at least one of the following: discarding the current KgNB key, the KRRCenc key, the KRRCint key, the KUPint key and the KUPenc key; resetting MAC and releasing default MAC cell group configuration; re-establishing RLC entities of at least radio bearers supporting a transmission in the inactive state; suspending SRB1 and at least the radio bearers supporting a transmission in the inactive state; or performing PDCP suspend for DRBs.

In some embodiments, the circuitry may be further configured to: in accordance with a determination that the resume of the connection with the network device is to be performed at a further cell different from the cell where the transmission has been performed, perform the resume of the connection by initiating the state variable in the PDCP re-establishment. In some embodiments, the circuitry may further configured to perform PDCP suspend for at least DRBs supporting a transmission in an inactive state before the PDCP re-establishment.

In some embodiments, a terminal device comprises circuitry configured to: transmit, at a terminal device, uplink data in an inactive state to a network device; and in accordance with a determination that a resume of a connection with the network device is requested to be performed at a cell where the transmission has been performed, enter an idle state. In some embodiments, the circuitry may be further configured to: determine whether the same UE context or the same security key is to be used, and if the same UE context or the same security key is to be used, enter the idle state.

In some embodiments, the circuitry may be configured to abort the transmission in response to at least one of the following during the transmission: receiving, from the network device, a message for rejecting the transmission; further uplink data arriving from at least one radio bearer not supporting a transmission in the inactive state; a NAS layer or an AS layer of the terminal device requesting a transition to a connected state; receive signal power of a serving cell of the terminal device being lower than a threshold power; or a cell reselection being performed from a first cell to a second cell.

In some embodiments, the circuitry may be configured to abort the transmission by at least one of the following: discarding the current KgNB key, the KRRCenc key, the KRRCint key, the KUPint key and the KUPenc key; resetting MAC and releasing default MAC cell group configuration; re-establishing RLC entities of the radio bearers supporting a transmission in the inactive state; suspending SRB1 and at least the radio bearers supporting a transmission in the inactive state; or performing PDCP suspend for DRBs.

In some embodiments, the circuitry may be further configured to: in accordance with a determination that the resume of the connection with the network device is to be performed at a further cell different from the cell where the transmission has been performed, perform the resume of the connection by initiating the state variable in the PDCP re-establishment. In some embodiments, the circuitry may be further configured to perform PDCP suspend for at least DRBs supporting a transmission in an inactive state before the PDCP re-establishment.

In some embodiments, a terminal device comprises circuitry configured to: transmit, at a terminal device, uplink data in an inactive state to a network device, wherein no message for rejecting the transmission is received from the network device during the transmission of the uplink data in the inactive state.

In some embodiments, a terminal device comprises circuitry configured to: transmit, at a terminal device, uplink data in an inactive state to a network device; receive, from the network device, a message for resuming a connection with the network device, the message indicating that a PDCP re-establishment is performed for radio bearers not supporting a transmission in the inactive state; and perform the resume by at least one of the following: performing the PDCP re-establishment for the radio bearers, or resuming the radio bearers not supporting a transmission in the inactive state.

In some embodiments, a terminal device comprises circuitry configured to: transmit, at a terminal device, uplink data in an inactive state to a network device; receive downlink data from the network device; and in accordance with a determination that a checking of integrity protection of the downlink data fails, enter an idle state. In some embodiments, the circuitry may be further configured to store information of the failure.

In some embodiments, a network device comprises circuitry configured to: receive, at a network device, uplink data transmitted from a terminal device in an inactive state, wherein no message for rejecting the transmission is transmitted from the network device to the terminal device after the receipt of the uplink data.

In some embodiments, a network device comprises circuitry configured to: receive, at the network device, uplink data transmitted from a terminal device in an inactive state; and transmit, to the terminal device, a message for resuming a connection between the terminal device and the network device for the uplink data, the message indicating that a PDCP re-establishment is performed for radio bearers not supporting a transmission in the inactive state.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 13. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-18. (canceled)

19. A method of a User Equipment (UE), the method comprising:
initiating a Small Data Transmission (SDT) procedure;
receiving a Radio Resource Control (RRC) Reject message; and
re-establishing a Radio Link Control (RLC) entity for a radio bearer that is configured for the SDT procedure, upon reception of the RRC Reject message in a case where the SDT procedure is initiated.

20. The method according to claim 19,
wherein the radio bearer is a Data Radio Bearer (DRB), and
wherein the method further comprises:
performing a Packet Data Convergence Protocol (PDCP) suspend for the DRB, upon reception of the RRC Reject message in a case where the SDT procedure is initiated.

21. The method according to claim 19, further comprising:
suspending a Signaling Radio Bearer 1 (SRB1) and the radio bearer, upon reception of the RRC Reject message in a case where the SDT procedure is initiated.

22. The method according to claim 19, further comprising:
discarding a current KgNB key, a KRRCenc key, a KRRCint key, a KUPint key and a KUPenc key, upon reception of the RRC Reject message.

23. The method according to claim 19, further comprising:
resetting a Media Access Control (MAC) and releasing a default MAC cell group configuration, upon reception of the RRC Reject message.

24. A User Equipment (UE) comprising:
a memory; and
a processor coupled with the memory, wherein the processor is configured to:
initiate a Small Data Transmission (SDT) procedure;
receive a Radio Resource Control (RRC) Reject message; and
re-establish a Radio Link Control (RLC) entity for a radio bearer that is configured for the SDT procedure, upon reception of the RRC Reject message in a case where the SDT procedure is initiated.

25. The UE according to claim 24,
wherein the radio bearer is a Data Radio Bearer (DRB), and
wherein the processor is configured to:
perform a Packet Data Convergence Protocol (PDCP) suspend for the DRB, upon reception of the RRC Reject message in a case where the SDT procedure is initiated.

26. The UE according to claim 24,
wherein the processor is configured to:
suspend a Signaling Radio Bearer 1 (SRB1) and the radio bearer, upon reception of the RRC Reject message in a case where the SDT procedure is initiated.

27. The UE according to claim 24,
wherein the processor is configured to:
discard a current KgNB key, a KRRCenc key, a KRRCint key, a KUPint key and a KUPenc key, upon reception of the RRC Reject message.

28. The UE according to claim 24,
wherein the processor is configured to:
reset a Media Access Control (MAC) and release a default MAC cell group configuration, upon reception of the RRC Reject message.
